(19) United States
(12) Patent Application Publication
(10) Pub. No.: US 2015/0314432 A1
(43) Pub. Date: Nov. 5, 2015

(54) DRIVING TOOL

(71) Applicant: MAKITA CORPORATION, Aichi (JP)

(72) Inventors: Ying YANG, Anjo-Shi (JP); Kenya YANAGIHARA, Anjo-Shi (JP)

(73) Assignee: MAKITA CORPORATION, ANJO-SHI (JP)

(21) Appl. No.: 14/440,143

(22) PCT Filed: Nov. 1, 2013
(86) PCT No.: PCT/JP2013/079799

§ 371 Date: May 1, 2015

(30) Foreign Application Priority Data
Nov. 5, 2012 (JP) 2012-243442

(51) Int. Cl. B25C 1/00; B25C 1/06; B25C 1/04

(52) U.S. Cl. CPC B25C 1/008; B25C 1/04; B25C 1/06

(57) ABSTRACT

A driving tool, such as a nailer, includes a compression cylinder, a compression piston, an electric motor, a control apparatus, a trigger, a trigger switch, a driver guide, and a contact-arm switch. The control apparatus prevents fasteners, such as nails, from being driven when the controller identifies a state, in which it is likely that a malfunction or mis-operation of the driving tool is occurring.

### CROSS-REFERENCE

This application is the US national stage of International Patent Application No. PCT/JP2013/079799 filed on Nov. 1, 2013, which claims priority to Japanese Patent Application No. 2012-243442 filed on Nov. 5, 2012.

### TECHNICAL FIELD

The present invention generally relates to a driving (power) tool that drives a driven article, such as a fastener, into a workpiece.

### BACKGROUND ART

A driving tool that drives a driven article (fastener) into a workpiece is described in U.S. Pat. No. 8,079,504. In this driving tool, compressed air generated by a first piston inside a first cylinder is supplied to a second cylinder. Furthermore, the compressed air moves a second piston within the second cylinder. When the second piston moves, the second piston strikes the driven article and thereby drives it toward the workpiece. In this driving tool, the drive of a motor is controlled by switching a switch ON and OFF.

### SUMMARY OF THE INVENTION

However, in the above-described driving tool, there is a possibility that the driving tool might operate incorrectly (malfunction) if the switch malfunctions. That is, it is possible that a driven article (fastener) might be driven out contrary to the intention of the operator.

Accordingly, an object of the present teachings is to provide one or more improved techniques to improve the safety of a driving tool.

In one aspect of the present teachings, a driving tool preferably comprises: a cylinder; a piston capable of sliding within the cylinder; a motor that drives the piston; a controller that controls the motor; a first movable member that, based on a user operation performed when the user drives the driven article, makes contact with a workpiece and thereby is moved from a first position to a second position; a first switch configured such that it is in an OFF state if the first movable member is positioned at the first position and in an ON state if the first movable member is positioned at the second position; a second movable member that is operated by the user when the user drives the driven article and thereby is moved from the third position to the fourth position; and a second switch configured such that it is in the OFF state if the second movable member is positioned at the third position and in the ON state if the second movable member is positioned at the fourth position. In this driving tool, a battery for supplying electric current to the motor is configured such that the battery is attachable and detachable. The controller, if both the first switch and the second switch change to the ON state, generates an air pressure change inside the cylinder by driving the motor and the driven article is thereby driven as a result of the pressure change. The controller inhibits (prevents) the driving of the driven article in at least one case from among: the case in which it is detected that the first switch is in the ON state when the first movable member is positioned at the first position; the case in which it is detected that the second switch is in the ON state when the second movable member is positioned at the third position, the case in which it is detected that the first switch is in the ON state continuously for a prescribed time when the first movable member is positioned at the second position; and the case in which it is detected that the second switch is in the ON state continuously for a prescribed time when the second movable member is positioned at the fourth position. For example, the first movable member may be configured as a contact arm that, based on a user operation, makes contact with the workpiece and thereby is moved; and the second movable member may be configured as a trigger that is directly operated by a finger of the user.

According to another aspect of the present teachings, the controller inhibits (prevents) the driving of the driven article in the case in which it is detected that the first switch is in the ON state when the first movable member is positioned at the first position or in the case in which it is detected that the second switch is in the ON state when the second movable member is positioned at the third position.

Because the first switch is configured to change to the OFF state when the first movable member is positioned at the first position, it is understood that the first switch is not operating normally in case it is in the ON state while the first movable member is positioned at the first position. Likewise, because the second switch is configured to change to the OFF state when the second movable member is positioned at the third position, it is understood that the second switch is not operating normally in case it is in the ON state while the second movable member is positioned at the third position. Therefore, in embodiments according to this aspect, the controller inhibits (prevents) the driving of driven articles when either of these abnormal states is detected and thereby driven articles are prevented from being unintentionally driven. That is, if a malfunction occurs in any of the first switch, the second switch, the member that actuates the first switch, the member that actuates the second switch, etc., then driven articles are prevented from being driven. As a result, the first switch and the second switch also function, in effect, as a safety apparatus.

According to another aspect of the present teachings, the controller inhibits (prevents) the driving of the driven article in the case in which it is detected that at least one of the first switch and the second switch is in the ON state when the battery is mounted onto the driving tool.

According to this aspect, when the user is mounting the battery onto the driving tool, the user is normally not (simultaneously) performing the operation for driving a driven article. Therefore, if it determined that at least one of the first switch and the second switch is in the ON state when the battery is being mounted, then it is determined that there is a malfunction in the first switch, the second switch, or the like. Consequently, the controller inhibits (prevents) the subsequent driving of driven articles and thereby, in the state in which the first switch, the second switch, or the like is malfunctioning, the driving tool is prevented from unintentionally driving any driven articles (fasteners). In addition, when the battery is mounted, it is possible to check whether a malfunction is occurring in the first switch, the second switch, or the like.

According to another aspect of the present teachings, the driving tool comprises: a change-over switch that switches between an electric-current-supply permitted state that permits the supply of electric current from the battery to the controller and an electric-current-supply cutoff state that cuts off the supply of electric current. Furthermore, the controller inhibits (prevents) the driving of the driven article if it is detected that at least one of the first switch and the second switch is in the ON state when the change-over switch is switched from the electric-current-supply cutoff state to the electric-current-supply permitted state. The change-over switch is typically configured as a main (power) switch that starts up the driving tool.

According to this aspect, when switching the change-over switch, the user is normally not performing the operation for driving a driven article. Therefore, if at least one of the first switch and the second switch is in the ON state when the change-over switch is switched from the electric-current-supply cutoff state to the electric-current-supply permitted state, then it is determined that there is a malfunction in the first switch, the second switch, or the like. Consequently, the controller inhibits (prevents) the subsequent driving of driven articles and thereby, in the state in which the first switch, the second switch, or the like is malfunctioning, the driving tool is prevented from unintentionally driving any driven articles. In addition, when the change-over switch is switched, it is possible to check whether a malfunction is occurring in the first switch, the second switch, or the like.

According to another aspect of the present teachings, the controller inhibits (prevents) the driving of the driven article if it is detected that the first switch is in the ON state continuously for the prescribed time when the first movable member is positioned at the second position or if it is detected that the second switch is in the ON state continuously for the prescribed time when the second movable member is positioned at the fourth position.

If either of the switches is in the ON state continuously for a prescribed time, then there is a possibility that the driven article will be unintentionally driven not only in the case in which a malfunction is occurring in the first switch, the second switch, or the like, but also in the case in which the first switch and the second switch are operating normally. Therefore, according to the present aspect, if either of the switches is in the ON state continuously for a prescribed time, the driving of driven articles is inhibited (prevents) and thereby driven articles can be prevented from being driven unintentionally. Furthermore, “the switch is in the ON state continuously for a prescribed time” preferably includes, for example, the case in which a switch fails, the case in which a member that actuates a switch fails, the case in which the user operates the driving tool improperly, and the like.

According to another aspect of the present teachings, the controller permits the subsequent driving of the driven article if it is detected that the first movable member is positioned at the first position and the first switch is in the OFF state and if it is detected that the second movable member is positioned at the third position and the second switch is in the OFF state.

According to this aspect, if it can be confirmed that the first switch and the second switch are operating normally again, then the driving of a driven article is permitted. As a result, the driving tool can be driven in a rational manner.

According to another aspect of the present teachings, the driving tool comprises: an informing means that indicates to the user that the driving of the driven article is being inhibited (prevents) by the controller. A light-emitting means, a vibration-generating means, a sound-generating means, or the like is preferably used as the informing means. An LED, a laser-radiating device, or the like may be used as the light-emitting means. A means that comprises a motor and generates vibrations by the rotation of the motor may be used as the vibration-generating means. In addition, a means that comprises a speaker and outputs a recorded sound source from the speaker may be used as the sound-generating means.

According to this aspect, the user can be informed, via the informing means, that the first switch or the second switch is not operating normally and consequently the controller is inhibiting (preventing) the driving of the driven article.

According to the present teachings, it is possible to provide improved techniques for safely operating a driving tool.

Other features, functions, and effects of the present teachings can be readily understood by referring to the present specification, the claims, and the attached drawings.

### BRIEF DESCRIPTION OF THE DRAWINGS

FIG. 1 is an external view that shows the overall configuration of an electro-pneumatic nailer according to the present teachings.

FIG. 2 is a view taken in the direction of arrow A shown in FIG. 1.

FIG. 3 is a cross sectional view that shows the overall configuration of an internal mechanism of the nailer.

FIG. 4 is a cross sectional view taken along line IV-IV shown in FIG. 3.

FIG. 5 is a cross sectional view taken along line V-V shown in FIG. 2.

FIG. 6 is a cross sectional view taken along line VI-VI shown in FIG. 3 and shows the state in which a valve is closed.

FIG. 7 shows a nailing state in which the valve in FIG. 6 has opened and the driving piston has moved forward.

FIG. 8 shows the state in which the open state of the valve is maintained and the driving piston has returned nearly to the rearward initial position shown in FIG. 6.

FIG. 9 is a block diagram that shows a control system of the nailer.

### DETAILED DESCRIPTION

The structural elements and methods described above and below may be used separately or in conjunction with other structural elements and methods to manufacture and use driving tools according to the present teachings. Representative embodiments of this invention include these combinations and will be described in detail with reference to the attached drawings. The detailed description below merely teaches a person skilled in the art detailed information for practicing preferred examples of the present invention and does not limit the technical scope of the present invention, which is defined based on the text of the claims. Therefore, combinations of structural elements, method steps, and the like in the detailed explanation below are, in a broad sense, not all essential to practice the invention and instead merely disclose, in the detailed explanation given in conjunction with the reference numerals in the attached drawings, representative aspects of the present invention.

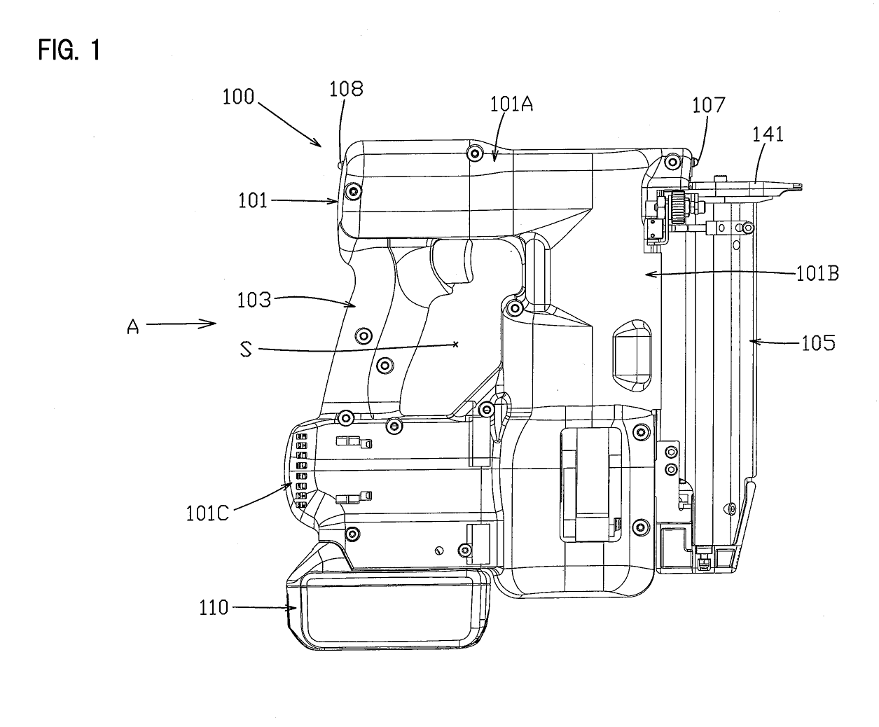

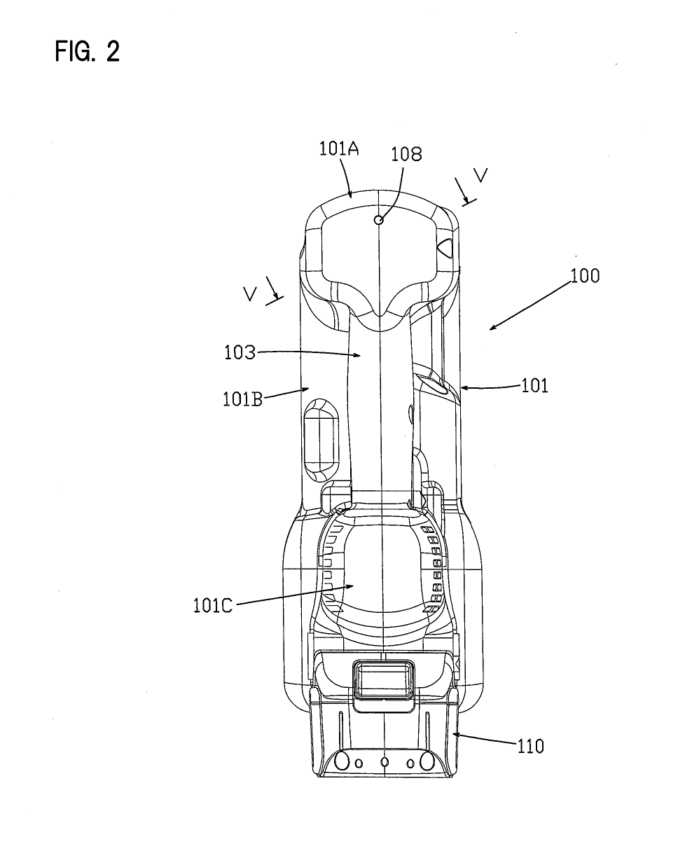

A representative embodiment will be explained below, with reference to FIG. 1 through FIG. 9. The present embodiment is explained using an electro-pneumatic nailer as one example of a driving tool according to the present teachings. As shown in the overall views of FIG. 1 and FIG. 2, a nailer 100 principally comprises a main-body housing 101 and a magazine 105. The main-body housing 101 is configured as a tool main body and forms an outer wall of the nailer 100. The magazine 105 is loaded with nails (not illustrated) to be driven into a workpiece. The main-body housing 101 is formed by joining together a pair of substantially symmetrical housings. The main-body housing 101 comprises a handle part 103, a driving-mechanism-housing part 101A, a compression-apparatus-housing part 101B, and a motor-housing part 101C.

The handle part 103, the driving-mechanism-housing part 101A, the compression-apparatus-housing part 101B, and the motor-housing part 101C are disposed such that they generally form a rectangular shape. The handle part 103 is an elongate member that extends with a prescribed length. One-end side of the handle part 103 is joined to one-end side of the driving-mechanism-housing part 101A and the other-end side of the handle part 103 is joined to one-end side of the motor-housing part 101C. Moreover, the compression-apparatus-housing part 101B is disposed such that it extends substantially parallel to the handle part 103. One-end side of the compression-apparatus-housing part 101B is joined to an other-end side of the driving-mechanism-housing part 101A, and an other-end side of the compression-apparatus-housing part 101B is joined to an other-end side of the motor-housing part 101C. Thereby, in the nailer 100, a (hollow) space S is formed that is surrounded by the handle part 103, the driving-mechanism-housing part 101A, the compression-apparatus-housing part 101B, and the motor-housing part 101C.

As shown in FIG. 1, a driver guide 141 and an LED 107 are disposed at a tip part (the right end in FIG. 1) of the nailer 100. The rightward direction in FIG. 1 is the nail driving direction. Furthermore, for the sake of convenience of explanation, the tip side (the right side in FIG. 1) of the nailer 100 is called the front side, and the side opposite the tip side (the left side in FIG. 1) is called the rear side. In addition, the side of the nailer 100 (the upper side in FIG. 1) to which the driving-mechanism-housing part 101A of the handle part 103 is joined is called the upper side, and the side of the nailer 100 (the lower side in FIG. 1) to which the motor-housing part 101C of the handle part 103 is joined is called the lower side.

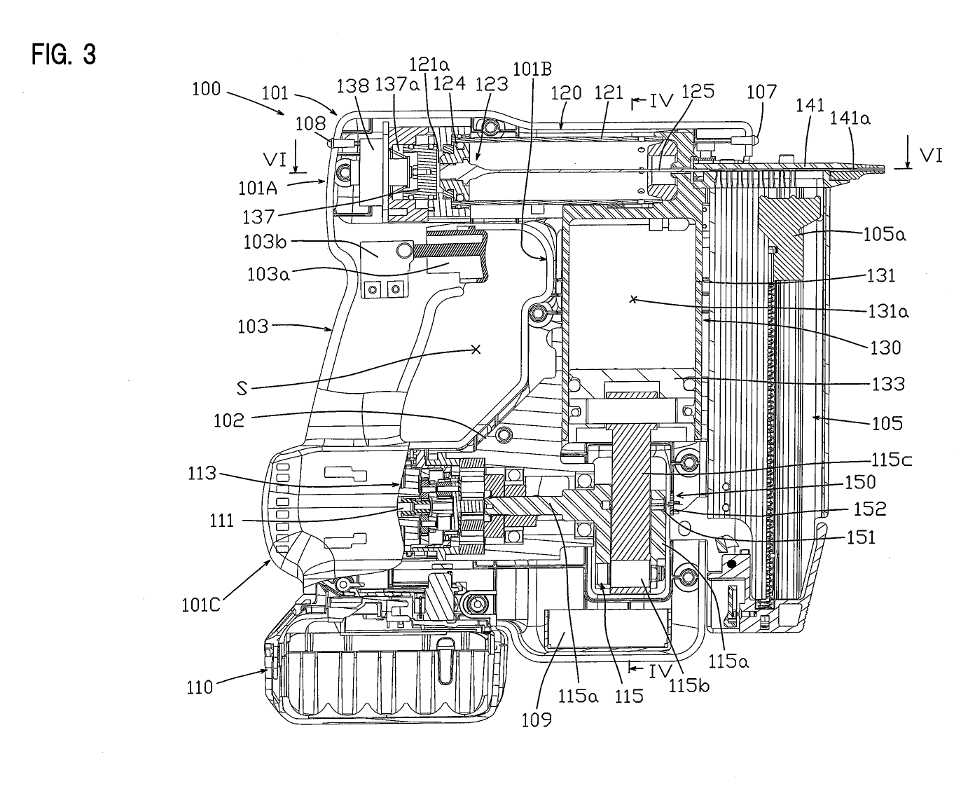

As shown in FIG. 3, the driving-mechanism-housing part 101A houses a nail-driving mechanism 120. The nail-driving mechanism 120 principally comprises a driving cylinder 121 and a driving piston 123.

The driving cylinder 121 houses the driving piston 123 such that the driving piston 123 is capable of sliding in the front-rear directions (the longitudinal-axis direction). The driving piston 123 comprises a piston-main-body part 124 and a driver 125. The driver 125 is an elongate member. The driver 125 is integrally provided with the piston-main-body part 124 and is disposed such that it extends forward. The piston-main-body part 124 and the driver 125 are configured such that they are capable of reciprocally moving along the longitudinal-axis direction of the driving cylinder 121 by supplying compressed air into a cylinder chamber 121a. Thereby, the driver 125 moves forward within a driving passage 141a of the driver guide 141 and thereby drives a nail. The driving-cylinder chamber 121a is formed as a space that is surrounded by an inner wall surface of the driving cylinder 121 and a rear side surface of the piston-main-body part 124. The driver guide 141 is disposed at a tip part of the driving cylinder 121 and has the driving passage 141a, which has a nail ejection port at its tip.

As shown in FIG. 1, the magazine 105 is disposed on the tip side of the main-body housing 101, that is, forward of the compression-apparatus-housing part 101B. The magazine 105 houses the nails, which are the driven articles. In addition, the magazine 105 is coupled to the driver guide 141 and supplies the nails to the driving passage 141a. Furthermore, as shown in FIG. 3, the magazine 105 is provided with a pusher plate 105a for pushing the nails in a supplying direction (upward in FIG. 3). The nails are supplied, one nail at a time, by the pusher plate 105a to the driving passage 141a of the driver guide 141 from a direction that intersects the driving direction.

As shown in FIG. 3, the compression-apparatus-housing part 101B houses a compression apparatus 130. The compression apparatus 130 principally comprises a compression cylinder 131, a compression piston 133, and a crank mechanism 115. The compression piston 133 is disposed, such that it is capable of sliding in the up-down directions, within the compression cylinder 131. The compression cylinder 131 and the compression piston 133 are example embodiments that correspond to a “cylinder” and a “piston,” respectively, in the present teachings.

The compression cylinder 131 is disposed along the magazine 105, and an upper-end side of the compression cylinder 131 is joined to a front-side end part of the driving cylinder 121. Furthermore, the compression piston 133 is disposed such that it slides in the up-down directions along the magazine 105. The operation directions of the compression piston 133 are substantially orthogonal to the operation directions of the driving piston 123. The volume of a compression chamber 131a, which is an internal space of the compression cylinder 131, changes owing to the compression piston 133 sliding in the up-down directions. That is, the movement of the compression piston 133 toward the upward side, which reduces the volume of the compression chamber 131a, compresses air in the compression chamber 131a. The compression chamber 131a is formed on an upper-part side that is proximate to the driving cylinder 121. In addition, the compression cylinder 131 comprises an atmosphere open valve (not illustrated) and is configured such that it is capable of opening the compression chamber 131a to the atmosphere. The atmosphere open valve is normally held in a closed state.

As shown in FIG. 3, the motor-housing part 101C houses an electric motor 111. The electric motor 111 is disposed such that the rotational axis of the motor shaft is substantially parallel to the longitudinal axis of the driving cylinder 121. Accordingly, the rotational axis of the electric motor 111 is orthogonal to the operation direction of the compression piston 133. Furthermore, a battery-mount area is formed on a lower-part side of the motor-housing part 101C, and a rechargeable battery pack 110 that supplies electric power to the electric motor 111 is attachably and detachably mounted to the battery-mount area. The battery pack 110 is an example embodiment that corresponds to a “battery” in the present teachings.

As shown in FIG. 3, the rotational speed of the electric motor 111 is reduced by a planetary-gear-type, speed-reducing mechanism 113, after which the rotation is transmitted to the crank mechanism 115. Furthermore, the rotation of the electric motor 111 is converted into linear motion by the crank mechanism 115 and then transmitted to the compression piston 133. The speed-reducing mechanism 113 and the crank mechanism 115 are housed in an inner-side housing 102. The inner-side housing 102 is disposed between the compression-apparatus-housing part 101B and the motor-housing part 101C. The electric motor 111 is an example embodiment that corresponds to a “motor” in the present teachings.

As shown in FIG. 3, the crank mechanism 115 principally comprises a crankshaft 115a, an eccentric pin 115b, and a connecting rod 115c. The crankshaft 115a is joined to the planetary-gear-type, speed-reducing mechanism 113. That is, the crankshaft 115a is rotationally driven by the rotation of the electric motor 111, the speed of which has been reduced by the speed-reducing mechanism 113. The eccentric pin 115b is provided at a position that is offset from the center of rotation of the crankshaft 115a. One end of the connecting rod 115c is pivotally joined to the eccentric pin 115b, and the other end of the connecting rod 115c is pivotally joined to the compression piston 133. The crank mechanism 115 is disposed below the compression cylinder 131. Based on the above-described configuration, the compression apparatus 130 is configured as a reciprocating-type compression apparatus and principally comprises the compression cylinder 131, the compression piston 133, and the crank mechanism 115.

As shown in FIG. 3, the handle part 103 is provided with a trigger 103a and a trigger switch 103b. The trigger switch 103b transitions to the ON state by the performance of the operation in which the trigger 103a is pulled. Moreover, the trigger switch 103b transitions to the OFF state by ceasing the pulling operation of the trigger 103a. That is, the trigger 103a is configured to be movable between the front side (the right side in FIG. 3) position, at which the trigger 103a is not being operated by the user, and the rear side (the left side in FIG. 3) position, at which the trigger 103a has been operated by the user. Furthermore, when the trigger 103a is positioned on the front side, the trigger switch 103b is in the OFF state. Moreover, when the trigger 103a is positioned on the rear side, the trigger switch 103b is in the ON state. The trigger 103a and the trigger switch 103b are example embodiments that correspond to a “second movable member” and a “second switch,” respectively, in the present teachings. In addition, the front-side position and the rear-side position, at which the trigger 103a may be positioned, are example embodiments that correspond to a “third position” and a “fourth position,” respectively, in the present teachings.

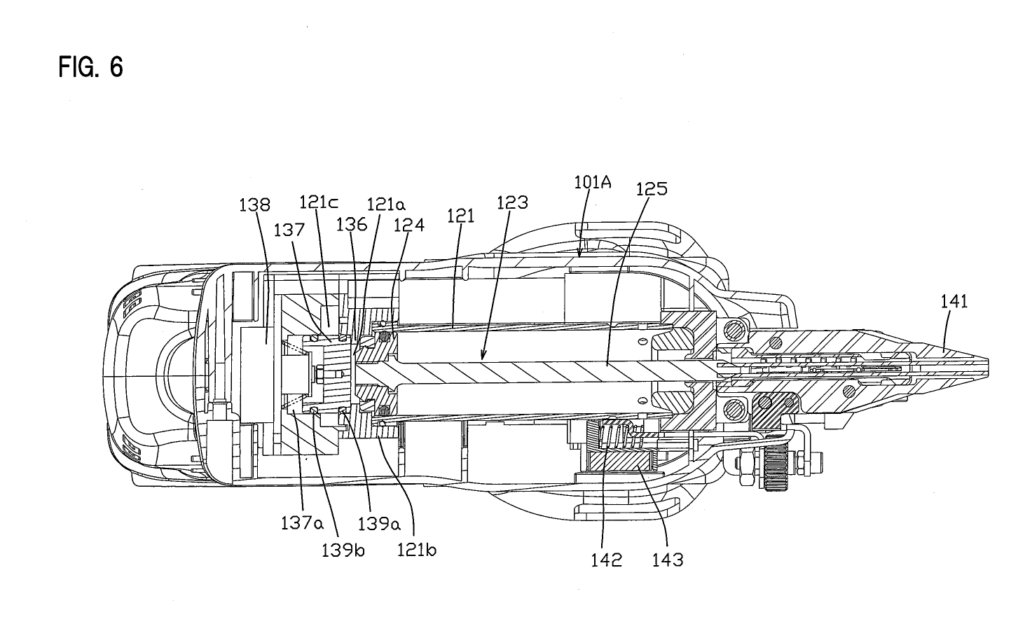

In addition, the driver guide 141, which serves as a contact arm, is disposed at the tip area of the main-body housing 101 such that it is capable of moving in the front-rear directions of the nailer 100. As shown in FIG. 6, the driver guide 141 is biased forwardly by a biasing spring 142. When the driver guide 141 is positioned forward, a contact-arm switch 143 is in the OFF state. Moreover, when the driver guide 141 is moved towards the side of the main-body housing 101, the contact-arm switch 143 transitions to the ON state. That is, the driver guide 141 is configured to be movable between the forward position and the rearward position, which is on the main-body housing 101 side. The driver guide 141 and the contact-arm switch 143 are example embodiments that correspond to a “first movable member” and a “first switch,” respectively, in the present teachings. In addition, the forward position and the rearward position, at which the driver guide 141 may be positioned, are example embodiments that correspond to a “first position” and a “second position,” respectively, in the present teachings.

As shown in FIG. 3, a control apparatus 109 is disposed below the crank mechanism 115. Furthermore, the electric motor 111 is configured such that it is controlled by the control apparatus 109 in accordance with the operation of the trigger 103a, which is provided on the handle part 103, and the operation of the driver guide 141, which is provided at the tip area of the main-body housing 101. That is, the electric motor 111 is energized and driven when the trigger switch 103b and the contact-arm switch 143 are both switched to the ON state, and stops when either the trigger switch 103b or the contact-arm switch 143 is switched to the OFF state. The control apparatus 109 is an example embodiment that corresponds to a “controller” in the present teachings.

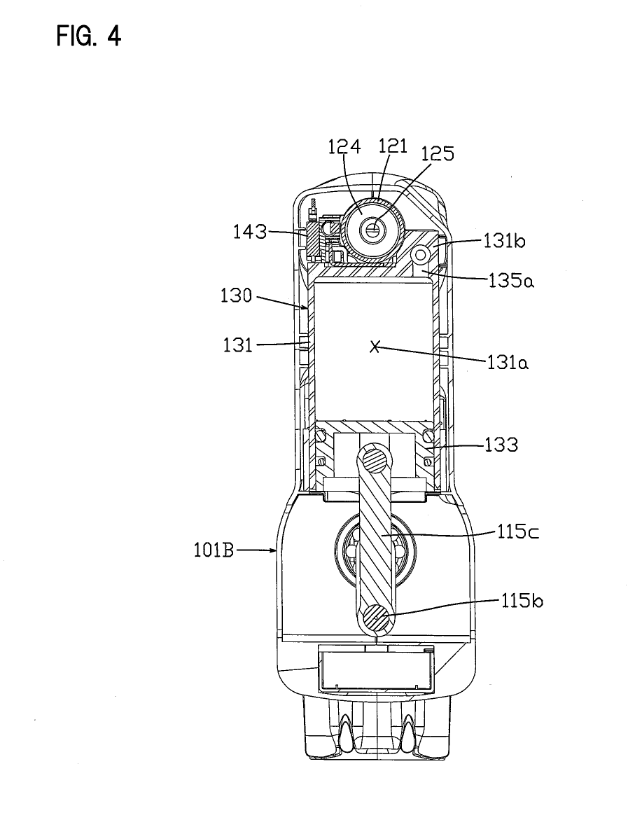

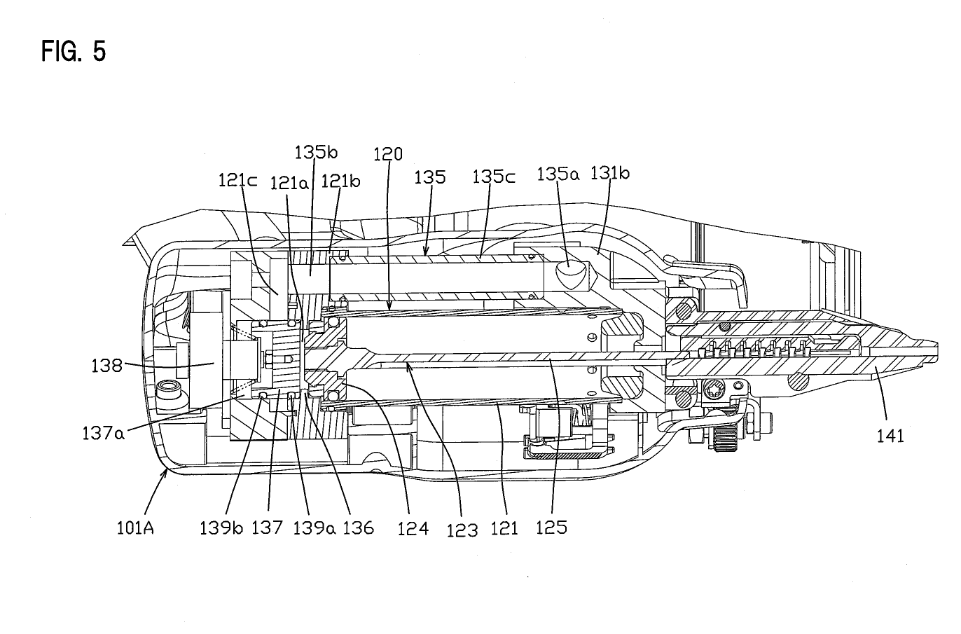

As shown in FIG. 5, the nailer 100 has an air passage 135 and a valve chamber 137a, which provide communication between the compression chamber 131a of the compression cylinder 131 and the cylinder chamber 121a of the driving cylinder 121. The air passage 135 principally comprises a communication port 135a, a communication port 135b, and a communication path 135c; an annular groove 121c and the valve chamber 137a are in fluid communication therewith. As shown in FIG. 4, the communication port 135a is formed in a cylinder head 131b of the compression cylinder 131. The communication port 135a communicates with the compression chamber 131a. In addition, as shown in FIG. 5, the communication port 135b is formed in a cylinder head 121b of the driving cylinder 121. The communication port 135b communicates with the valve chamber 137a. The communication path 135c provides communication between the communication port 135a and the communication port 135b. The communication path 135c extends linearly in the front-rear direction along the driving cylinder 121.

As shown in FIG. 5, the communication port 135b communicates with the annular groove 121c, which is formed in a circumferential surface of the valve chamber 137a. The annular groove 121c communicates with the valve chamber 137a. Furthermore, the valve chamber 137a communicates with the cylinder chamber 121a. Thereby, the communication port 135b communicates with the cylinder chamber 121a via the annular groove 121c and the valve chamber 137a. A solenoid valve 137, which opens and closes the air passage 135, is housed in the valve chamber 137a.

The solenoid valve 137 is a cylindrical member having a diameter substantially the same as that of the piston-main-body part 124 of the driving piston 123. The solenoid valve 137 is disposed, such that it is capable of moving in the front-rear directions, within the valve chamber 137a. An electromagnet 138 is disposed rearward of the solenoid valve 137. Furthermore, the solenoid valve 137 moves in the front-rear directions by switching the supply of power to the electromagnet 13. Two O-rings 139a, 139b are disposed on the outer circumference of the solenoid valve 137 at a prescribed spacing in the front-rear direction. The solenoid valve 137 opens and closes the annular groove 121c by moving rearward and forward, respectively.

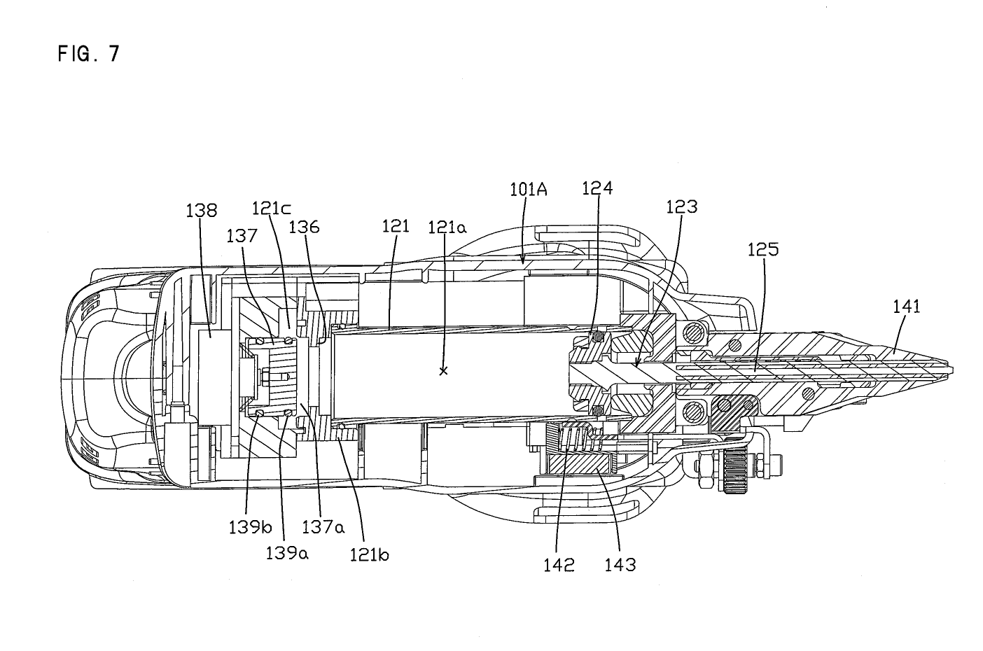

Specifically, as shown in FIG. 6, the O-ring 139a, which is on the front side, blocks the communication between the annular groove 121c and the cylinder chamber 121a by contacting the inner-wall surface of the valve chamber 137a forward of the annular groove 121c. In addition, as shown in FIG. 7, when the O-ring 139a moves into the region of the annular groove 121c, the annular groove 121c communicates with the cylinder chamber 121a. Furthermore, the O-ring 139b, which is on the rear side, prevents the compressed air from leaking out of the communication port 135b to the outer side. That is, the O-ring 139b does not contribute to the opening and closing of the annular groove 121c. Thus, the solenoid valve 137, which opens and closes the air passage 135, is provided on the side of the air passage 135 on which the cylinder chamber 121a of the driving cylinder 121 is connected.

As shown in FIG. 6, the solenoid valve 137 is disposed forward by the electromagnet 138 such that the annular groove 121c is normally closed. In addition, a stopper 136 is disposed forward of the solenoid valve 137 and limits the forward movement of the solenoid valve 137. The stopper 136 is formed by a flange-shaped member that protrudes in the radial direction inside the cylinder chamber 121a. Furthermore, the stopper 136 defines a rear-end position of the rearward movement of the driving piston 123.

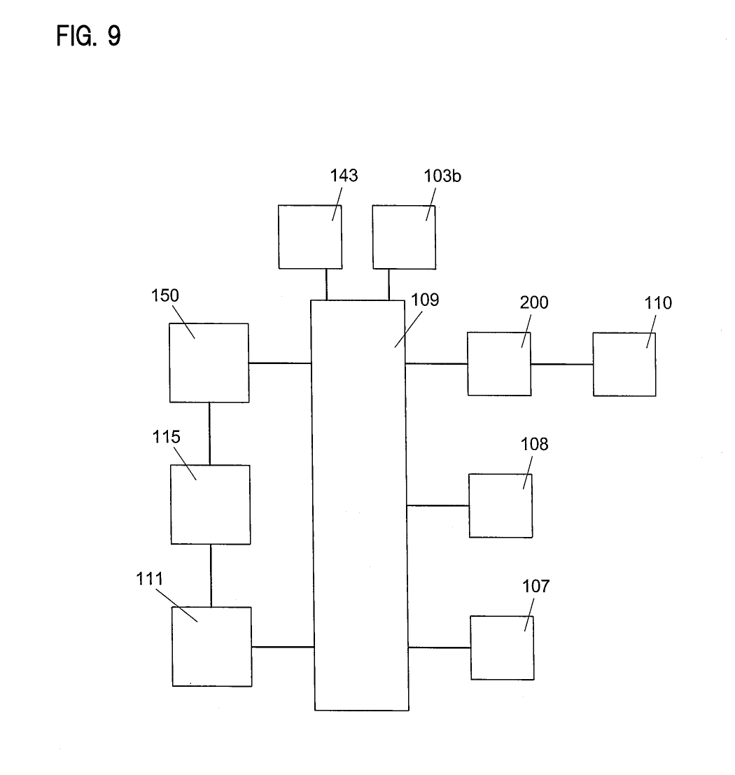

Next, the operation of the nailer 100 will be explained. As shown in FIG. 9, the nailer 100 comprises a main (power) switch 200, which is connected to the control apparatus 109. When the main switch 200 is in the ON state, electric current is supplied from the battery pack 110 to the electric motor 111 via the control apparatus 109. On the other hand, when the main switch 200 is in the OFF state, the supply of electric current from the battery pack 110 is cut off. That is, the main switch 200 is provided as a main-power-supply switch. The main switch 200 is an example embodiment that corresponds to a “change-over switch” in the present teachings.

When the main switch 200 has been switched to the ON state, as shown in FIG. 3, the driving piston 123 is positioned at a final-end position (the left-end position in FIG. 3); furthermore, the state in which the compression piston 133 is positioned at a lowermost-end position (bottom dead center) is defined as the initial position. That is, the initial state is when the crank angle is 0° (bottom dead center).

As shown in FIG. 3, the nailer 100 comprises a magnetic sensor 150. The magnetic sensor 150 principally comprises a magnet 151 and a Hall-effect device 152. The magnet 151 is provided on the crankshaft 115a. Moreover, the Hall-effect device 152 is provided at a position of the compression-apparatus-housing part 101B opposing the magnet 151. The Hall-effect device 152 is electrically connected to the battery pack 110 via the control apparatus 109. The Hall-effect device 152 detects the position of the crankshaft 115a, and the control apparatus 109 defines as the initial state the state in which the compression piston 133 is positioned at the bottom dead center.

Starting from the initial state shown in FIG. 3, when the user intends to perform an operation to drive a nail and thereby presses the driver guide 141 against the workpiece, which changes the contact-arm switch 143 (refer to FIG. 6) to the ON state, and pulls the trigger 103a, which switches the trigger switch 103b to the ON state, the electric motor 111 is energized and driven. Thereby, the crank mechanism 115 is driven via the speed-reducing mechanism 113, and the compression piston 133 moves upward. At this time, because the solenoid valve 137 closes the air passage 135, the air inside the compression chamber 131a is compressed by the movement of the compression piston 133.

When the magnetic sensor 150 detects that the position of the compression piston 133 is an uppermost-end position (top dead center), which is a crank angle of 180°, the control apparatus 109 controls the electromagnet 138 so as to move the solenoid valve 137 rearward. That is, when the compressed air inside the compression chamber 131a has reached its maximum compression state, the solenoid valve 137 opens. Thereby, the annular groove 121c communicates with the cylinder chamber 121a, and the compressed air inside the compression chamber 131a is supplied into the cylinder chamber 121a via the air passage 135. When the compressed air is supplied into the cylinder chamber 121a, the driving piston 123 is moved forward by the action of the air spring produced by the compressed air, as shown in FIG. 7. Furthermore, the driver 125 of the driving piston 123, which has moved forward, strikes the nail that is standing by in the driving passage 141a (refer to FIG. 3). Thereby, a driving operation is performed in which one nail is driven.

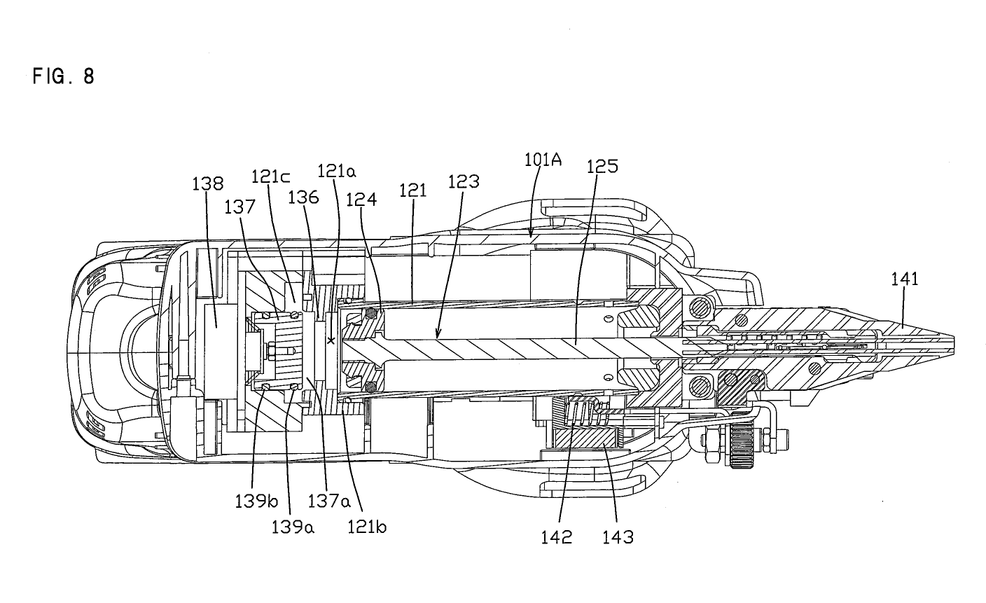

After the driving operation, the compression piston 133 moves toward the bottom dead center. At that time, the volume of the compression chamber 131a increases and the air pressure inside the compression chamber 131a becomes a negative pressure that is lower than atmospheric pressure. The negative pressure that arose inside the compression chamber 131a acts on the driving piston 123 via the air passage 135 and the cylinder chamber 121a. Thereby, as shown in FIG. 8, the driving piston 123 is suctioned and is moved rearward. Furthermore, the driving piston 123 makes contact with the stopper 136 and is positioned at the initial position. When the magnetic sensor 150 detects that the position of the compression piston 133 is the bottom dead center, which is a crank angle of 0°, the control apparatus 109 controls the electromagnet 138 so as to move the solenoid valve 137 forward. Thereby, the air passage 135 closes. Furthermore, when the compression piston 133 returns to the initial position, the supply of electric current to the electric motor 111 is cut off, and the electric motor 111 is stopped. Thus, one cycle of the driving operation ends. Furthermore, during the driving operation, the LED 107 illuminates (irradiates) the tip area of the driver guide 141.

In case that the trigger switch 103b is maintained in the ON state after the compression piston 133 has returned to the initial position, the driving tool is configured such that another driving operation is performed by resetting the contact-arm switch 143, which had changed to the OFF state, to the ON state. That is, while the trigger 103a remains the state in which it is actuated, one nail is driven each time the driver guide 141 is (repeatedly) pressed against the workpiece. Thereby, a continuous driving operation can be performed, in which nails are consecutively driven while the user continuously holds the trigger 103a in the ON state. Furthermore, the driving tool is also configured such that, if the contact-arm switch 143 is maintained in the ON state after a nail has been driven, another driving operation is not performed even if the trigger 103a is operated (squeezed) again and the ON/OFF state of the trigger switch 103b switches.

The above-mentioned nailer 100 is configured such that a nail is driven when both switches, that is, the trigger switch 103b and the contact-arm switch 143, change to the ON state. In other words, the trigger switch 103b and the contact-arm switch 143 function as a safety apparatus that prevents a nail from being unintentionally driven as a result of incorrect operation by the user or the like. Accordingly, the trigger switch 103b and the contact-arm switch 143 need to operate normally. Consequently, in the present embodiment, it is detected in the driving operation whether the trigger switch 103b and the contact-arm switch 143, which are actuated based on user operations, are operating normally. Furthermore, if either of the switches is not operating normally, then the control apparatus 109 inhibits (prevents) the driving of a nail. That is, the unintentional driving of a nail is inhibited (prevent) in the state in which one or both of the switches is (are) not operating normally.

The trigger switch 103b is in a normally operating state (a normal state) if the trigger switch 103b is in the OFF state when the trigger 103a is positioned on the front side, at which the trigger 103a is not being operated by the user, and in the ON state when the trigger 103a is positioned on the rear side, at which the trigger 103a is being operated by the user. Accordingly, if the trigger switch 103b is in the ON state in spite of the fact that the trigger 103a is positioned on the front side, at which the trigger 103a is not being operated by the user, then the trigger switch 103b is not operating normally. That is, the trigger switch 103b is in an abnormal state.

Likewise, the contact-arm switch 143 is in a normally operating state (a normal state) if the contact-arm switch 143 is in the OFF state when the driver guide 141 is positioned forward and in the ON state when, owing to a user operation during a driving operation, the driver guide 141 is pressed against the workpiece and is positioned rearward. Accordingly, the contact-arm switch 143 is not operating normally if the contact-arm switch 143 is in the ON state in spite of the fact that the driver guide 141 is not pressed against the workpiece and consequently is positioned forward. That is, the contact-arm switch 143 is in an abnormal state.

Consequently, the present embodiment is configured such that the control apparatus 109 detects, at a prescribed timing, whether the trigger switch 103b and the contact-arm switch 143 are operating normally. That is, if the trigger switch 103b is in the ON state when the trigger 103a is positioned on the front side, at which the trigger 103a is not being operated by the user, or if the contact-arm switch 143 is in the ON state when the driver guide 141 is positioned forward, at which the driver guide 141 is not being pressed against the workpiece, then the control apparatus 109 determines that there is a malfunction in either of the switches or in the element that actuates either of the switches. In this case, the control apparatus 109 inhibits the subsequent driving of nails. That is, the control apparatus 109 inhibits (cuts off) the supply of electric current to the electric motor 111.

In the nailer 100, the above-mentioned prescribed timings are defined as the time when the user mounts the battery pack 110 and/or the time when the user switches the main (power) switch 200 to the ON state. That is, the time when the battery pack 110 is mounted and the time when the main switch 200 is switched to the ON state are points in time prior to the user using the nailer 100 to perform a driving operation. At such points in time, the user is normally not operating the trigger 103a, pressing the driver guide 141 against the workpiece, or the like. In other words, the trigger 103a is positioned on the front side, at which the trigger 103a is not being operated, and the driver guide 141 is positioned forward, at which the driver guide 141 is not pressed against the workpiece. Accordingly, if the trigger switch 103b and the contact-arm switch 143 are in the normal state, then each switch is in the OFF state.

If either switch, that is, the trigger switch 103b or the contact-arm switch 143, is in the ON state when the user mounts the battery pack 110 and/or when the user switches the main switch 200 to the ON state, then it can be determined that there is a malfunction in the switch or in an element that actuates the switch. Accordingly, the control apparatus 109 inhibits the subsequent driving of nails. As a result, it is possible to prevent the unintentional driving of a nail.

In addition, in the continuous driving operation, the trigger switch 103b is maintained (held) in the ON state; however, if a prescribed time has elapsed without the ON/OFF state of the contact-arm switch 143 being switched, then the control apparatus 109 inhibits the subsequent driving of nails. That is, if the user is not performing a driving operation in spite of it being in continuous driving operation, then the control apparatus 109 determines that it is not in continuous driving operation. That is, the user operation is determined to be a misoperation. Accordingly, the control apparatus 109 cuts off the supply of electric current to the electric motor 111, thereby inhibiting the further driving of nails. Furthermore, in this case, if the trigger switch 103b is subsequently switched to the OFF state, then the control apparatus 109 cancels the inhibition of the driving of nails. The above-mentioned prescribed time is set to, for example, five seconds.

If the control apparatus 109 inhibits the driving of nails, then the control apparatus 109 causes the LED 107, 108 to be turned ON. Thereby, the drive of the electric motor 111 is stopped and the fact that the driving of nails is being inhibited is reported/indicated to the user. Furthermore, the control apparatus 109 may not only turn the LEDs 107, 108 ON but may also flash them ON and OFF. In addition, the control apparatus 109 may be configured so as to change the color of the lights generated by the LEDs 107, 108. In addition, it may be configured so as to turn ON or flash ON/OFF just one of the LEDs 107, 108.

According to the embodiment described above, the driving of nails is inhibited (prevented) if a malfunction is detected in either of the switches, that is, the trigger switch 103b or the contact-arm switch 143. Thereby, in the state in which there is a malfunction in the trigger switch 103b, the contact-arm switch 143, or the like, nails are prevented from being unintentionally driven.

In addition, according to the present embodiment, the fact that there is a malfunction in the trigger switch 103b, the contact-arm switch 143, or either of the elements, that is, in the trigger 103a that actuates the trigger switch 103b or in the driver guide 141 that actuates the contact-arm switch 143, is detected.

In addition, according to the present embodiment, the control apparatus 109 inhibits the driving of nails based on the ON/OFF state of the trigger switch 103b and the contact-arm switch 143 when the battery pack 110 is mounted, when the main switch 200 is switched to the ON state, and the like. Consequently, the driving of nails can be inhibited without detecting the position of the trigger 103a that actuates the trigger switch 103b, the position of the driver guide 141 that actuates the contact-arm switch 143, and the like.

In addition, according to the present embodiment, in the continuous driving operation, if the user absently (inadvertently) operates (squeezes) the trigger 103a continuously for a long time, then the subsequent driving of nails is inhibited, and thereby the driving of a nail due to the inattention or incorrect operation by the user, or the like, is prevented.

In addition, according to the present embodiment, the fact that the driving of nails is being inhibited can be reported/indicated by the LEDs 107, 108. That is, the user can ascertain, by viewing the LEDs 107, 108, that a malfunction has been detected in the nailer 100.

In the above, the control apparatus 109 is configured to detect whether the trigger switch 103b and the contact-arm switch 143 are operating normally when the user mounts the battery pack 110 and/or when the user switches the main switch 200 to the ON state, but it is not limited thereto. For example, the control apparatus 109 may be configured such that it is capable of always detecting whether the trigger switch 103b and contact-arm switch 143 are operating normally. That is, the control apparatus 109 may be configured such that sensors that detect the position of the trigger 103a and the position of the driver guide 141, respectively, are provided, and the control apparatus 109 detects whether the trigger switch 103b and the contact-arm switch 143 are operating normally based on the relationship between the positions of the trigger 103a and the driver guide 141 and the ON/OFF states of the trigger switch 103b and the contact-arm switch 143.

In addition, in the above, when the battery pack 110 is mounted, when the main switch 200 is switched to the ON state, or the like, the user normally is not operating the trigger 103a and the driver guide 141 is normally not pressed against the workpiece; consequently, if either of the switches, that is, the trigger switch 103b or the contact-arm switch 143, is in the ON state, then it is determined that the switch is in an abnormal state, but it is not limited thereto. For example, depending on the state in which the nailer 100 is situated, it is possible that the trigger 103a, the driver guide 141, or the like is being operated even though the user is mounting the battery pack 110 and/or the user is switching the main switch 200 to the ON state. In addition, there is also the possibility of a case in which a malfunction occurs in the trigger 103a, the driver guide 141, or the like, and thereby the trigger 103a, the driver guide 141, or the like is not positioned at a position at which it is not being operated. Consequently, the driving tool may be configured such that, when the user mounts the battery pack 110 and/or when the user switches the main switch 200 to the ON state, the control apparatus 109 inhibits (prevents) the driving of nails if either of the switches, that is, the trigger switch 103b or the contact-arm switch 143, is in the ON state, regardless of the state of the nailer 100. That is, at the above-mentioned prescribed timings, regardless of the position of the trigger 103a and/or the position of the driver guide 141, the case in which either of the switches, that is, the trigger switch 103b or the contact-arm switch 143, is in the ON state may be regarded as an abnormal state. In the case of an abnormal state, the control apparatus 109 inhibits the driving of nails. Furthermore, in this case, the driving tool is configured such that, if the trigger switch 103b and the contact-arm switch 143 subsequently change to the OFF state, then the control apparatus 109 permits the subsequent driving of nails.

In addition, in the above, the LEDs 107, 108 are provided as informing means, but there may be just one LED. In addition, a buzzer that generates sound, an actuator that generates vibrations, or the like may be provided as the informing means.

In addition, in the above, the battery pack 110 is configured in an attachable and detachable manner, but it is not limited thereto. The battery pack 110 may be fixed to the nailer 100 as long as it is rechargably configured.

Taking into consideration the above objects of the present teachings, the following aspects of the driving tool according to the present teachings can be configured.

### (Aspect 1)

A driving tool that drives a driven article (fastener) out of an ejection port, comprising:
a cylinder;
a piston capable of sliding within the cylinder;
a motor that drives the piston;
a controller that controls the motor;
a first movable member that, based on a user operation performed when the user drives the driven article, makes contact with a workpiece and thereby is moved from a first position to a second position;
a first switch configured such that it is in an OFF state if the first movable member is positioned at the first position and in an ON state if the first movable member is positioned at the second position;
a second movable member that is operated by the user when the user drives the driven article and thereby is moved from a third position to a fourth position; and
a second switch configured such that it is in the OFF state if the second movable member is positioned at the third position and in the ON state if the second movable member is positioned at the fourth position;
   wherein,
a battery for supplying electric current to the motor is configured such that the battery is attachable;
the controller is configured to, if both the first switch and the second switch change to the ON state, generate an air pressure change inside the cylinder by driving the motor and thereby drive the driven article by the pressure change;
the battery is configured such that it is attachable to and detachable from the driving tool; and
the controller is configured to inhibit the driving of the driven article in the case in which it is detected that at least one of the switches among the first switch and the second switch is in the ON state when the battery is mounted.

### (Aspect 2)

A driving tool that drives a driven article from an ejection port, comprising:
a cylinder;
a piston capable of sliding within the cylinder;
a motor that drives the piston;
a controller that controls the motor;
a first movable member that, based on a user operation performed when the user drives the driven article, makes contact with a workpiece and thereby is moved from a first position to a second position;
a first switch configured such that it is in an OFF state if the first movable member is positioned at the first position and in an ON state if the first movable member is positioned at the second position;
a second movable member that is operated by the user when the user drives the driven article and thereby is moved from a third position to a fourth position; and
a second switch configured such that it is in the OFF state if the second movable member is positioned at the third position and in the ON state if the second movable member is positioned at the fourth position;
   wherein,
a battery for supplying electric current to the motor is configured such that the battery is attachable;
the controller is configured to, if both the first switch and the second switch change to the ON state, generate an air pressure change inside the cylinder by driving the motor and thereby drive the driven article by the pressure change;
   comprising:
a change-over switch that switches between an electric-current-supply permitted state that permits the supply of electric current from the battery to the controller and an electric-current-supply cutoff state that cuts off the supply of electric current;
   wherein,
the controller is configured to inhibit the driving of the driven article if it is detected that at least one of the switches among the first switch and the second switch is in the ON state when the change-over switch is switched from the electric-current-supply cutoff state to the electric-current-supply permitted state.

### (Aspect 3)

The driving tool according to aspects 1 or 2, wherein
the controller is configured to permit the subsequent driving of the driven article if it is detected that the first switch is in the OFF state and if it is detected that the second switch is in the OFF state.

### (Aspect 4)

The driving tool according to any one of claims 1-8 or aspects 1-3, wherein
the first movable member is a contact arm that, based on a user operation, makes contact with the workpiece and thereby is moved; and
the second movable member is a trigger that is directly operated by a finger of the user.

### EXPLANATION OF THE REFERENCE NUMBERS

100 Nailer
101 Main-body housing
101A Driving-mechanism-housing part
101B Compression-apparatus-housing part
101C Motor-housing part
102 Inner-side housing
103 Handle part
103a Trigger
103b Trigger switch
105 Magazine
105a Pusher plate
107 LED
108 LED
109 Control apparatus
110 Battery pack
111 Electric motor
113 Speed-reducing mechanism
115 Crank mechanism
115a Crankshaft
115b Eccentric pin
115c Connecting rod
120 Nail-driving mechanism
121 Driving cylinder
121a Cylinder chamber
121b Cylinder head
121c Annular groove
123 Driving piston
124 Piston-main-body part
125 Driver
130 Compression apparatus
131 Compression cylinder
131a Compression chamber
131b Cylinder head
133 Compression piston
135 Air passage
135a Communication port
135b Communication port
135c Communication path
136 Stopper
137 Solenoid valve
137a Valve chamber
138 Electromagnet
139a O-ring
139b O-ring
141 Driver guide
141a Driving passage
142 Biasing spring
143 Contact-arm switch
150 Magnetic sensor
151 Magnet
152 Hall-effect device
200 Main switch

1. A driving tool configured to drive a driven article out of an ejection port, comprising:
a cylinder;
a piston slidably housed within the cylinder;
a motor configured to drive the piston;
a controller configured to control operation of the motor;
a first movable member configured to be moved from a first position to a second position by a user pressing the first movable member against a workpiece in order to drive the driven article into the workpiece;
a first switch configured to be in an OFF state when the first movable member is positioned at the first position and in an ON state when the first movable member is positioned at the second position;
a second movable member configured to be moved from a third position to a fourth position by the user in order to initiate a driving operation; and
a second switch configured to be in the OFF state when the second movable member is positioned at the third position and in the ON state when the second movable member is positioned at the fourth position;
wherein,
the driving tool is configured to detachably mount a battery for supplying electric current to the motor;
the controller is configured to, if both the first switch and the second switch change to the ON state, generate an air pressure change inside the cylinder by driving the motor and thereby drive the driven article as a result of the pressure change; and
the controller is configured to prevent the motor from driving the piston and thus preventing the driven article from being driven when one of the following states is detected:
the first switch is in the ON state while the first movable member is positioned at the first position;
the second switch is in the ON state while the second movable member is positioned at the third position;
the first switch has been in the ON state continuously for a first predetermined period of time while the first movable member is positioned at the second position; or
the second switch has been in the ON state continuously for a second predetermined period of time while the second movable member is positioned at the fourth position.

2. The driving tool according to claim 1, wherein
the controller is configured to prevent the driving of the driven article when one of the following states is detected:
the first switch is in the ON state while the first movable member is positioned at the first position or
the second switch is in the ON state while the second movable member is positioned at the third position.

3. The driving tool according to claim 2, wherein
the controller is configured to prevent the driving of the driven article when it is detected that the first switch and/or the second switch is in the ON state at the time that the battery is mounted.

4. The driving tool according to claim 2, further comprising:
a change-over switch configured to switch between an electric-current-supply permitted state that permits the supply of electric current from the battery to the controller and an electric-current-supply cutoff state that cuts off the supply of electric current;
wherein,
the controller is configured to prevent the driving of the driven article when it is detected that the first switch and/or the second switch is in the ON state at the time that the change-over switch is switched from the electric-current-supply cutoff state to the electric-current-supply permitted state.

5. The driving tool according to claim 2, wherein
the controller is configured to prevent the driving of the driven article when it is detected that:
the first switch is in the ON state continuously for the first predetermined period of time while the first movable member is positioned at the second position or
the second switch is in the ON state continuously for the second predetermined period of time while the second movable member is positioned at the fourth position.

6. The driving tool according to claim 1, wherein
the controller is configured to prevent the driving of the driven article when it is detected that:
the first switch is in the ON state continuously for the first predetermined period of time while the first movable member is positioned at the second position or
the second switch is in the ON state continuously for the second predetermined period of time while the second movable member is positioned at the fourth position.

7. The driving tool according to claim 6, wherein
the controller is configured to subsequently permit the driving of the driven article when it is detected that:
the first movable member is positioned at the first position and the first switch is in the OFF state and
the second movable member is positioned at the third position and the second switch is in the OFF state.

8. The driving tool according to claim 1, comprising:
an informing means for indicating to the user that the driving of the driven article is being prevented by the controller.

9. The driving tool according to claim 1, wherein
the first movable member is a contact arm configured to contact the workpiece and be moved from the first position to the second position when the user presses the driving tool against the workpiece; and
the second movable member is a trigger configured to be directly operated by a finger of the user.

10. The driving tool according to claim 3, further comprising:
a change-over switch configured to switch between an electric-current-supply permitted state that permits the supply of electric current from the battery to the controller and an electric-current-supply cutoff state that cuts off the supply of electric current;
wherein,
the controller is configured to prevent the driving of the driven article when it is detected that the first switch and/or the second switch is in the ON state at the time that the change-over switch is switched from the electric-current-supply cutoff state to the electric-current-supply permitted state.

11. The driving tool according to claim 10, wherein
the controller is configured to prevent the driving of the driven article when it is detected that:
the first switch is in the ON state continuously for the first predetermined period of time while the first movable member is positioned at the second position or
the second switch is in the ON state continuously for the second predetermined period of time while the second movable member is positioned at the fourth position.

12. The driving tool according to claim 11, wherein
the controller is configured to subsequently permit the driving of the driven article when it is detected that:
the first movable member is positioned at the first position and the first switch is in the OFF state and
the second movable member is positioned at the third position and the second switch is in the OFF state.

13. The driving tool according to claim 12, wherein
the first movable member is a contact arm configured to contact the workpiece and be moved from the first position to the second position when the user presses the driving tool against the workpiece; and
the second movable member is a finger-operable trigger.

14. A driving tool comprising:
a first movable element configured to be movable from a first position to a second position when a user presses the first movable member against a workpiece in order to drive a driven article into the workpiece;
a first switch configured to be normally in an OFF state when the first movable member is positioned at the first position and switched to an ON state when the first movable member is moved to the second position;
a second movable member configured to be movable from a third position to a fourth position by the user in order to initiate a driving operation;
a second switch configured to be normally in an OFF state when the second movable member is positioned at the third position and switched to an ON state when the second movable member is moved to the fourth position; and
a controller configured to prevent the driving operation when one of the following states is detected:
(i) the first switch is in the ON state while the first movable member is positioned at the first position;
(i) the second switch is in the ON state while the second movable member is positioned at the third position;
(iii) the first switch has been continuously in the ON state for a first predetermined period of time while the first movable member is positioned at the second position; or
(iv) the second switch has been continuously in the ON state for a second predetermined period of time while the second movable member is positioned at the fourth position.

15. The driving tool according to claim 14, wherein:
the first movable member is a contact arm configured to contact the workpiece and be moved from the first position to the second position when the user presses the driving tool against the workpiece;
the second movable member is a finger-operable trigger;
a piston is slidably housed within the cylinder
a motor is configured to drive the piston and
the controller is configured to:
detect when the first switch and the second switch are both switched to the ON states, and in response thereto, drive the motor to generate an air pressure change inside the cylinder in order to drive the driven article into the workpiece,
detect states (i) and (ii) when a detachable battery is electrically coupled to the driving tool.

16. A method of operating a driving tool, wherein the driving tool comprises:
a first movable element configured to be movable from a first position to a second position when a user presses the first movable member against a workpiece in order to drive a driven article into the workpiece;
a first switch configured to be normally in an OFF state when the first movable member is positioned at the first position and switched to an ON state when the first movable member is moved to the second position;
a second movable member configured to be movable from a third position to a fourth position by the user in order to initiate a driving operation; and
a second switch configured to be normally in an OFF state when the second movable member is positioned at the third position and switched to an ON state when the second movable member is moved to the fourth position;
the method comprising:
preventing the driving operation when one of the following states is detected:
(i) the first switch is in the ON state while the first movable member is positioned at the first position;
(i) the second switch is in the ON state while the second movable member is positioned at the third position;
(iii) the first switch has been continuously in the ON state for a first predetermined period of time while the first movable member is positioned at the second position; or
(iv) the second switch has been continuously in the ON state for a second predetermined period of time while the second movable member is positioned at the fourth position.

17. The method according to claim 16, wherein the states (i) and (ii) are detected when a main power switch of the driving tool is switched from an OFF state to an ON state.

18. The method according to claim 16, wherein the states (i) and (ii) are detected when a detachable battery is electrically coupled to the driving tool.

19. The method according to claim 18, wherein
the first movable member is a contact arm configured to contact the workpiece and be moved from the first position to the second position when the user presses the driving tool against the workpiece; and
the second movable member is a finger-operable trigger.

20. The method according to claim 19, wherein the driving tool further comprises a piston slidably housed within the cylinder and a motor that drives the piston and the method further comprises:
detecting when the first switch and the second switch are both switched to the ON states, and
in response thereto, driving the motor to generate an air pressure change inside the cylinder in order to drive the driven article into the workpiece.
